(19) United States
(12) Patent Application Publication
(10) Pub. No.: US 2014/0156115 A1
(43) Pub. Date: Jun. 5, 2014

(54) METHOD FOR DISPLAYING AN AERONAUTICAL FLIGHT PLAN COMPRISING A STEP OF DISPLAYING AND SELECTING THE TASKS TO BE ACCOMPLISHED BEFORE A CHANGE OF FLIGHT PHASE

(71) Applicant: Thales, Neuilly Sur Seine (FR)

(72) Inventors: Bruno AYMERIC, St Medard En Jalles (FR); Cecile ANDRE, Bordeaux (FR); Yannick LE ROUX, St Medard En Jalles (FR)

(21) Appl. No.: 14/091,300

(22) Filed: Nov. 26, 2013

(30) Foreign Application Priority Data
Nov. 30, 2012 (FR) 1203248

(51) Int. Cl. G08G 5/00

(52) U.S. Cl. CPC G08G 5/0034; G08G 5/0039
USPC 701/3

(57) ABSTRACT

The general field of the invention is that of methods of graphical representation, modification and validation of an aeronautical flight plan for an aircraft avionics system. Said system comprises means for computing said flight plan, a system for managing the tasks necessary for the accomplishment of said flight plan, a visualization device displaying a graphical representation of said flight plan and a man-machine interface able to carry out selections, modifications or additions in the information contained in said graphical representation, said selections, modifications and additions being taken into account by the task management system. The graphical representation comprises a timeline on which feature at least the various phases of the flight plan and the corresponding information. The method comprises a step of displaying at least one first interactive graphical icon, representative of the overall state of progress of the tasks to be performed before a change of flight phase.

The field of the invention is that of the presentation, modification and validation of the aeronautical flight plans presented on aircraft cockpit visualization devices.

Aircraft cockpits contain several visualization screens intended to present to the pilot the necessary information for piloting or navigation. By means of man-machine interfaces the pilot can control, modify and validate this information. Generally, the flight plans are presented in text form. The screen displays a cartographic representation of the overflown terrain containing the flight plan with its various waypoints. This cartographic representation includes a table containing several rows. Each row represents a waypoint and supplies a certain amount of data relating to this waypoint such as, for example, the provisional time of transit, fuel consumption, etc.

This representation has a certain number of drawbacks. It only represents the flight phase of the craft and includes no information relating to the taxiing phase, towards the runway or the stand. This representation is sequential. Each row corresponds to one waypoint and all the waypoints are treated in the same way, whereas they may, for example, be separated by very different distances. Thus, whatever the distance between two points, the display between these waypoints is the same. Moreover, the various actions to perform to provide or look ahead to the various phases of the flight are not present and are only accessible on other visualization screens and by other means.

The Applicant has filed a patent application published under the reference FR 2 969 124 and titled “Procédé d'affichage temporel de la mission d'un aéronef” (“Method for time-based display of an aircraft mission”) proposing a different way of presenting aeronautical flight plans. In this way of presenting, the various steps of the flight plan are displayed in a graphic window containing scaled time axis or Timeline, the various steps being displayed opposite the time of their performance.

The method for displaying an aeronautical flight plan according to the invention reuses this Timeline concept. It also includes icons representative of the state of the tasks remaining to be accomplished before a change of flight phase of the craft, the icons affording access to the actions to be performed.

More precisely, the subject of the invention is a method of graphical representation, modification and validation of an aeronautical flight plan for an aircraft avionics system, said system comprising means for computing and generating said flight plan, a system for managing the tasks necessary for the accomplishment of said flight plan, a visualization device displaying a graphical representation of said flight plan and a man-machine interface able to carry out selections, modifications or additions in the information contained in said graphical representation, said selections, modifications and additions being taken into account by the task management system, said graphical representation comprising a timeline on which feature at least the various phases of the flight plan and the information corresponding to said phases.

Characterized in that the method comprises a step of displaying at least one first interactive graphical icon, representative of the overall state of progress of the tasks to be performed before a change of flight phase.

Advantageously, the selection by means of the man-machine interface of said first interactive graphical icon gives rise to the opening of a first graphical window comprising the namelist of the tasks to be accomplished, with each task is associated a second interactive graphical icon representative of the state of progress of said task.

Advantageously, the selection by means of the man-machine interface of a second interactive graphical icon gives rise to the opening of a second graphical window comprising the information list representative of the task associated with this second graphical icon, said information being able to be validated, modified or supplemented.

Advantageously, the graphical representation of the first interactive graphical icon comprises a first symbol representative of the forthcoming flight phase and a second symbol representative of the overall state of progress of the tasks to be performed before the change of flight phase.

Advantageously, when the overall state of progress of the tasks to be performed before the change of flight phase is judged inadequate by the avionics system of the aircraft, the second symbol is a prohibition panel.

Advantageously, when the flight phase is engaged although the set of tasks to be performed before the change of flight phase has not been performed in full, the second symbol comprises an amber or orange coloured zone.

Advantageously, when a task represented by the first graphical icon, after having been performed, has to be reinitialized, the graphical icon has a specific appearance representative of this reinitialization.

Advantageously, the carrying out of the set of tasks to be performed before the change of flight phase requests a determined time, the graphical representation of the flight plan comprises a specific representation of the first interactive graphical icon or a third specific icon implemented as soon as the time remaining before the change of phase is close to said determined time.

Advantageously, the man-machine interface is a touch-sensitive surface arranged on the visualization device.

The invention will be better understood and other advantages will become apparent on reading the following description, which is in no way limiting and refers to the appended figures, in which:

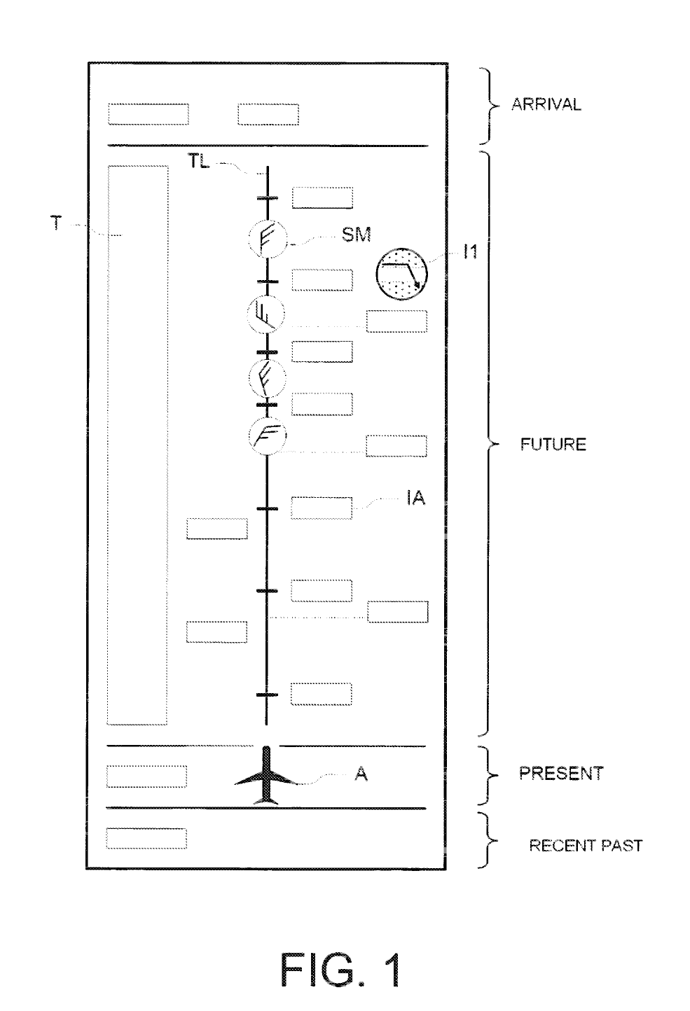

FIG. 1 represents a general view of the graphic representation of a flight plan according to the invention;

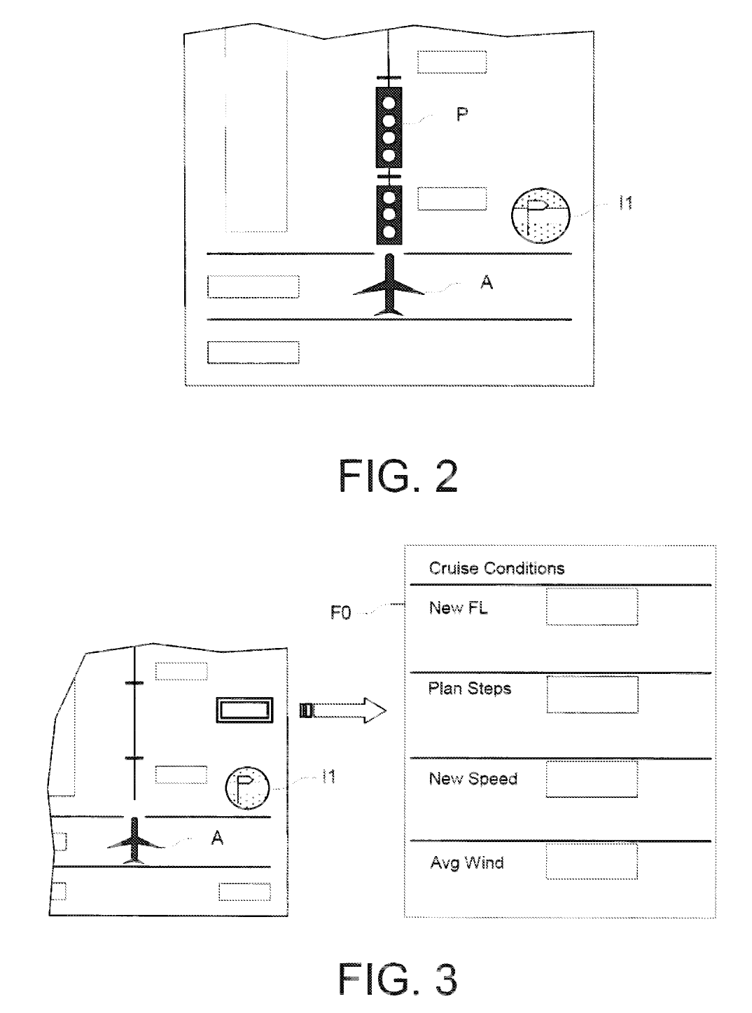

FIG. 2 represents a first partial detail view of a flight plan according to the invention;

FIG. 3 represents a second partial detail view of a flight plan according to the invention;

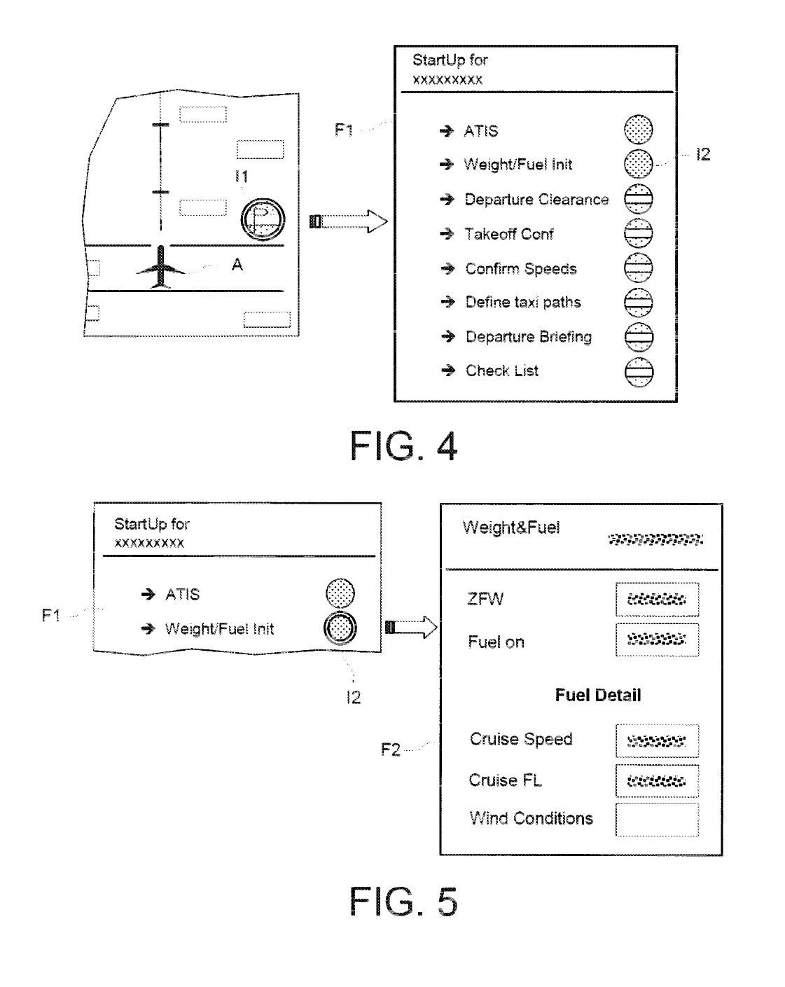

FIG. 4 represents a partial detail view of a flight plan according to the invention implementing a first icon according to the invention and a first associated window:

FIG. 5 represents a partial detail view of a flight plan according to the invention implementing a second window called by the first associated window according to the invention.

The implementation of the method according to the invention is carried out in an aircraft avionics system. This contains at least:
A flight management computer comprising the computing means and information needed to compute forecasts on the flight plan;
A breakdowns and alerts management computer known as the Flight Warning System;
A pilot flight information visualization device. This device is generally a flat screen arranged on the control panel;
A system for managing the actions to perform to change the phase of flight;
A man-machine interface. It is preferable that this interface be a so-called “multi-touch” touch-sensitive surface allowing the pilot to select, modify and validate the information necessary tor the flight in a very simple manner. However, a conventional interface system comprising a graphic cursor guided by a controller of computer “mouse” type is also suitable. In the following text, the man-machine interface is a touch-sensitive interface.

Of course, this list of means is not exhaustive. The system may contain dedicated means for meteorological information likely to affect flight conditions. More generally, the system may contain any means having an effect on the progress of an aircraft flight. These various means are present in all recent aircraft.

It should be noted that the term “flight plan” is understood to mean the totality of the mission carried out by the aircraft, said mission beginning with the taxiing phase before take-off and ending with the taxiing phase after landing of the aircraft.

The method according to the invention is implemented in the framework of a graphic presentation of the flight plan containing a Timeline. It is known that this type of graphic representation delivers logical link support between all the items of information necessary to the performance of the flight.

A graphic representation of the flight plan according to the invention is shown in FIG. 1. It contains a scaled time ax is T or “timeline” TL, the various phases of flight being displayed opposite the time corresponding to their performance. Preferably, the description of the flight is oriented from bottom to top. In fact, the cartographic display of the flight is usually oriented in this direction. The pilot may then more easily make the connection between the cartographic display and the ted display of the flight plan. The timeline contains a symbol representing an “aeroplane” model A. This model is situated, in standard operating mode, on the timeline at the current time. This graphic representation also contains the essential alphanumeric information IA about the required velocities, the required altitudes and the waypoints. The various figures also contain meteorological symbols SM representing the wind or meteorological phenomena. These symbols are conventionally represented by a system of directional arrows, wind barbs and pennants.

The various phases of the flight are structured into several zones:
A first zone relating to the recent past, denoted “RECENT PAST” When the flight has begun, this zone provides a reminder of the time of transit and other important parameters at the moment of passing particular waypoints. When the aircraft is effectively in flight, the crew may thus check these parameters against the forecasts made before the flight;
A second zone relating to the present, denoted “PRESENT”, in which are found, for example, the present time and the current mass of the aircraft;
A third zone describing the flight as a whole, denoted “FUTURE”. The pilot can control the beginning and the duration of the time slot displayed: the beginning may be either the current time, or a future time, or possibly a time in the past. Modifying the beginning of the slot is equivalent to moving in time. Modifying the duration makes it possible to see and to “zoom” in to more or less information. The system automatically manages the alterations to the display of the information as a function of the requested duration. For example, in FIG. 2, the requested duration is not compatible with a display of all the information relating to the phase of taxiing or take-off or “SID” (Standard Instrument Departure), so the system then only represents points P. On the other hand, certain important information contained in these phases is maintained. For example, the point where the flight management system foresees the attainment of a preset altitude may be permanently maintained;
A fourth zone relating to the arrival, denoted “ARRIVAL”. Here the time of arrival and distance to the destination are shown. If an emergency airport is defined in the flight plan, this airport is indicated along with the fuel forecast on arrival at this airport. This fuel forecast relates to the destination airport if no emergency airport has been defined.

The first so-called “recent past” zone is intended to enable the verification of the initial forecasts made before the flight against the actual performance during the flight. Thus, the selection of any element displayed in the recent past gives access to the display of a depiction representing the initial forecasts throughout the flight plan and the numbers achieved during the flight. Large deviations are highlighted in particular.

In the third flight zone, the operator can perform various actions and configurations. By way of example, he can configure the time slot displayed with very intuitive touch gesture interactions. When the beginning of the time slot is not the present, the separation between the present and flight zones is more marked. The aeroplane model is also represented differently. In this case, an interaction on this model makes it possible to immediately return the beginning of the time slot to the present. This interaction may be, for example, a double tap on the graphic representation of the model.

If the duration of the time slot is too small, source information is condensed. On the other hand, source information always remains available. For example, in FIG. 2, it can be seen that the taxiing and departure phases have been condensed. The points are only represented by dots and underlining identifies that a condensed phase is involved. In this configuration, a simple action makes it possible to select a time slot containing the phase alone.

Only the time is displayed over all of the waypoints. The fundamental velocity and altitude data are only displayed where they are characteristic. In the same way, the data concerning meteorological conditions and in particular the wind speed and direction are only displayed where they are characteristic. The display of these values enables the pilot to modify these configurations if desired, by selecting them as seen in FIG. 3. A window F0 then appears containing the detailed configuration information.

The fourth so-called arrival zone summarizes the most important forecasts and allows key actions relating to flight management. The items of information presented preferably are:
The time of arrival at the destination. Selecting the time of arrival opens an interface making it possible to configure anything that can affect the time of arrival in an intuitive manner. For example, this interface allows the ground to enter the take-off time, to influence the selected cruise velocity, etc.
The destination. Selecting this field summons an interface providing more complete forecasts at destination, such as, for example, the quantity of fuel remaining, and makes it possible to manage rerouting by selecting a new destination;
The “Alternative” or emergency airport. When this field has not yet been filled, selecting it allows access to a menu for inputting this airport. If it has already been input, the interface makes it possible to activate this airport and make it the new destination, or to consult more complete forecasts.
The quantity of fuel forecast at the moment of landing at the emergency airport. The presentation of this information is supplemented by an item of trend and alarm information if the forecast of the remaining quantity is drifting downwards. As the flight progresses, the forecast quantity of fuel decreases, and this is indicated to the pilot, in the form, for example, of an arrow to the right of the numerical value, pointing downwards. If the quantity approaches a critical minimum value, this is also represented, for example by changing the colour of the arrow.

In this general context of presentation of flight information, the method according to the invention consists in adding specific graphical icons or symbols in the flight zone at the points characteristic of a change of flight phase. More precisely, these icons are representative of the overall state of progress of the tasks to be performed before a change of flight phase.

In the various figures, this icon I1 has a circular shape. This shape is given by way of indication. Nonetheless, from the ergonomic standpoint, it is beneficial that the icon be “expressive”, that is to say it comprise symbols familiar to the pilot. The graphical representation of this interactive graphical icon comprises a first symbol representative of the forthcoming flight phase and a second symbol representative of the overall state of progress of the tasks to be performed before the change of flight phase. By way of example, the first symbol can be a downwards directed broken arrow indicating that the aircraft is going to commence its descent or a flag indicating that the aircraft is going to take off. In the various figures, the selected icons are represented surrounded by a double circle.

The second symbol can have several graphical representations, dependent on the overall state of progress of the tasks to be performed before the change of flight phase.

By way of first example, if actions remain to be executed before the transition in this phase, the second symbol represents a prohibition panel conventionally represented by a red or amber disc comprising a horizontal white bar. Such a representation is depicted in FIGS. 1 to 4.

The pilot can then select the symbol as seen in FIG. 4. The task management system requests the display of the list of tasks to be carried out in the form of a window F1. This list is ordered in an order which is parametrized with the texts provided by the various systems. With each task is associated a second interactive graphical icon I2 representative of the state of progress of said task.

When the task is carried out, this second icon is, for example, a “green light” represented by a green disc. When the task is not carried out, this second icon is, for example, a prohibition panel represented as previously. In FIG. 4, two icons are green lights and six are prohibition panels.

When the pilot requests a particular task, the task management system forewarns the display system that the associated interface is requested by the pilot. This leads to the display of a second interface or window F2 allowing the pilot to perform the required tasks. Advantageously, the interface which appears is the same as the interface which appears if the task is initialized by another procedure. For example, in FIG. 5, the task denoted “Weight/Fuel Init” which allows the system to ascertain the mass of the craft and of the fuel forms part of the tasks of the takeoff phase denoted “StartUp”. This interface is the same as if the initialization of the masses and initialized on the basis of the selection of the indication of mass or “growth weight” in the “present” zone or in the “arrival” zone.

If the system detects that a following phase has been entered although not all the actions have been carried out, an alarm is triggered. The system is capable of managing several types of alarms as a function of the criticality of the task not carried out: from a simple visual alert managed in an autonomous manner by the task manager through the presentation of the flight data, up to a sound alert rendered possible by connecting the task management system to the central alarms manager, also called the “Flight Warning System”.

By way of second example, the pilot may desire to override the initialization requests. He then considers that it is possible to enter the following phase of the flight although certain tasks are not carried out without risks. He can indicate this to the system. Thus, at each level, he is capable of indicating to the system that he considers the remaining tasks to be unnecessary or carried out elsewhere. The system then displays not a second symbol of green light type, or a prohibition symbol, but an alternative symbol representative of the overriding of the system. For example, this symbol can be a grey background with amber or orange highlighting indicating deactivation while maintaining a certain level of alert in regard to a non-nominal situation. Advantageously, the system can be parametrized to prohibit the overriding of certain tasks absolutely vital for safety. For example, this may be the case for the computation of the takeoff speeds.

By way of third example, if an action calls into question the past execution of a task, and therefore requires that this task be carried out again, the system is capable of reinitializing the presentation associated with the task by presenting a second prohibition symbol, while adding a characteristic attracting the pilots' attention to this particular task. This attention characteristic can be parametrized to be zero in certain cases, or very pressing such as, for example, a blinking of the symbol. The parametrization is dependent on the criticality of the task.

By way of fourth example, if the system anticipates that the action is lengthy to carry out and that the time remaining until the phase transition is short, characteristics of alerts are added to the prohibition symbol. This is particularly advantageous for certain transitions of phases such as descent or approach. Thus, the flight management system ascertains the time at which it considers that the descent stage should begin. Before this phase, the crew must have carried out a certain number of tasks consisting mainly of an initialization of the approach to the destination field. This preparation may be more or less lengthy. The present system therefore makes a prediction of the duration of preparation based on, for example, the destination field complexity computed on the basis of the number of runways, the number of approaches and the number of the standard arrivals and the meteorological conditions over the airport. When the predicted duration approaches the duration remaining until the transition, the system can forewarn the crew.

When an action or a task to be accomplished is managed by a determined system, such as, for example, the flight management system, and when this action forms part of the actions monitored by the system for managing the actions, this particular system warns the system for managing the actions upon the initialization of the flight, and then during flight. On initiation, this determined system gives:
The text to be associated with the display of the action;
The phase transition relevant to the action;
A discrete indicator of the criticality of the action, this indicator can be of the type “avoidable action” or “unavoidable action”;
A discrete indicator of the duration of the action, indicating to it whether or not this duration is pivotal. If this duration is pivotal, the system for managing the actions takes it into account to determine the duration remaining until the phase transition;
The reference of the interface to be unveiled so as to perform the action.

After initialization and during flight, this determined system gives the following information to the system for managing the actions:
State of the task which may be carried out, not carried out or overridden;
Duration of the task, if it is pivotal;
Reinitialization or “Reset” of the task, to indicate that a pilot action or an event has rendered it necessary to redo the task.

1. Method of graphical representation, modification and validation of an aeronautical flight plan for an aircraft avionics system, said system comprising means for computing and generating said flight plan, a system for managing the tasks necessary for the accomplishment of said flight plan, a visualization device displaying a graphical representation of said flight plan and a man-machine interface able to carry out selections, modifications or additions in the information contained in said graphical representation, said selections, modifications and additions being taken into account by the task management system, said graphical representation comprising a timeline on which feature at least the various phases of the flight plan and the information corresponding to said phases, wherein the method comprises a step of displaying at least one first interactive graphical icon, representative of the overall state of progress of the tasks to be performed before a change of flight phase.

2. Method of graphical representation, modification and validation of an aeronautical flight plan according to claim 1, wherein the selection by means of the man-machine interface of said first interactive graphical icon gives rise to the opening of a first graphical window comprising the namelist of the tasks to be accomplished, with each task is associated a second interactive graphical icon representative of the state of progress of said task.

3. Method of graphical representation, modification and validation of an aeronautical flight plan according to claim 2, wherein the selection by means of the man-machine interface of a second interactive graphical icon gives rise to the opening of a second graphical window comprising the information list representative of the task associated with this second graphical icon, said information being able to be validated, modified or supplemented.

4. Method of graphical representation, modification and validation of an aeronautical flight plan according to claim 1, wherein, when the overall state of progress of the tasks to be performed before the change of flight phase is judged inadequate by the avionics system of the aircraft, an alarm is triggered.

5. Method of graphical representation, modification and validation of an aeronautical flight plan according to claim 1, wherein, when the flight phase is engaged although the set of tasks to be performed before the change of flight phase has not been performed in full, an indication of overriding is given to the system.

6. Method of graphical representation, modification and validation of an aeronautical flight plan according to claim 1, wherein, the carrying out of the set of tasks to be performed before the change of flight phase requests a determined time, as soon as the time remaining before the change of phase is close to said determined time, the system implements means to forewarn the crew.

7. Method of graphical representation, modification and validation of an aeronautical flight plan according to claim 1, wherein the man-machine interface is a touch-sensitive surface arranged on the visualization device.
